(19) United States
(12) Patent Application Publication
(10) Pub. No.: US 2002/0160255 A1
(43) Pub. Date: Oct. 31, 2002

(54) Battery latch and method

(75) Inventors: Raymond Floyd Babcock, Stewartville, MN (US); Matthew Allen Butterbaugh, Rochester, MN (US); Noah Elijah Shirk, Rochester, MN (US); Yasuharu Yamada, Shiga-Ken (JP)

Correspondence Address: MARTIN & ASSOCIATES, LLC, P O BOX 548, CARTHAGE, MO, 64836-0548, US

(73) Assignee: International Business Machines Corporation, Armonk, NY (US)

(21) Appl. No.: 09/843,653

(22) Filed: Apr. 26, 2001

(51) Int. Cl. H01M 2/10

(52) U.S. Cl. 429/97; 429/123

(57) ABSTRACT

A battery latch for a portable electronic device is made of a resilient material and includes integral spring members that make the use of a separate steel spring unnecessary. The battery latch is low-profile, allowing it to be easily integrated into a housing with limited space. The battery latch includes protruding members that are biased by the integral spring members into a recess that is designed to receive the battery pack. The protruding members include a beveled or curved surface that the battery pack presses against when the battery pack is being pressed into place. The force of the battery pack overcomes the bias of the integral spring members and forces the battery latch into the housing, thereby making room for the battery pack to slide past the protruding members of the battery latch. The battery pack includes recesses that align with the protruding members of the battery latch once the battery pack is fully seated in the housing. As the battery pack is fully seated in the housing, the integral spring members push the protruding members into the recesses in the battery pack, thereby holding the battery pack in place. The battery latch includes a slide button that allows a user to disengage the battery latch from the battery pack so the battery pack can be removed from the housing. The battery latch can be assembled into a housing using no tools by simply snapping the slide button through a hole in the housing into the battery latch that is placed inside the housing.

### BACKGROUND OF THE INVENTION

1. Technical Field

This invention generally relates to portable devices and more specifically relates to portable devices that are battery-powered.

2. Background Art

Portable electronics have become very popular in recent years. Most portable electronic devices are powered by batteries. Some portable electronic devices use off-the-shelf batteries, while others use custom-shaped battery packs that are generally rechargeable. Examples of common portable electronics include mobile phones, pagers, hand-held computers, camcorders, notebook computers, CD players, radios, cassette players, etc.

The prior art provides different mechanisms for attaching a battery pack to a portable electronic device. For example, it is known to provide slots on a battery pack that align with rails on the device (or vice versa) that allow the battery pack to slide into place. Most portable electronic devices include some type of latch mechanism to hold the battery pack in place so that it does not inadvertently come off the portable electronic device. For example, many camcorders use battery packs that slide into place, with a latch that “clicks” when the battery pack is fully seated to retain the battery pack in place.

Known battery latches typically use a steel spring to bias the latch in one position, while allowing the latch to be moved against the spring tension to disengage the battery pack. Some battery latches are quite small and are used with devices that have limited space in the housing for a battery pack. For this reason, assembling a prior art battery latch that includes a separate metal spring is problematic. Without an improved battery latch, the portable electronic device industry will continue to suffer from inefficient assembly of battery latches and from the requirement to provide a separate spring for battery latches.

### DISCLOSURE OF INVENTION

According to the preferred embodiments, a battery latch for a portable electronic device is made of a resilient material and includes integral spring members that make the use of a separate steel spring unnecessary. The battery latch is low-profile, allowing it to be easily integrated into a housing with limited space. The battery latch includes protruding members that are biased by the integral spring members into a compartment that is designed to receive the battery pack. The protruding members include a beveled or curved surface that the battery pack presses against when the battery pack is being pressed into place. The force of the battery pack overcomes the bias of the integral spring members and forces the battery latch into the housing, thereby making room for the battery pack to slide past the protruding members of the battery latch. The battery pack includes recesses that align with the protruding members of the battery latch once the battery pack is fully seated in the housing. As the battery pack is fully seated in the housing, the integral spring members push the protruding members into the recesses in the battery pack, thereby holding the battery pack in place. The battery latch includes a slide button that allows a user to disengage the battery latch from the battery pack so the battery pack can be removed from the housing. The battery latch can be assembled into a housing using no tools by simply snapping the slide button through a hole in the housing into the battery latch that is placed inside the housing.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a top view of a battery latch in accordance with the preferred embodiments;

FIG. 2 is a side view of the battery latch in FIG. 1 taken along the line 2-2;

FIG. 3 is a top view of a slide button that is used in conjunction with the battery latch of FIG. 1 in accordance with the preferred embodiments;

FIG. 4 is a side view of the slide button in FIG. 3 taken along the line 4-4;

FIG. 5 is a side view of the slide button in FIG. 3 taken along the line 5-5;

FIG. 6 is a view that shows the battery latch assembled into a housing in accordance with the preferred embodiments with the latch in its extended position;

FIG. 7 is a view that shows the battery latch assembled into a housing in accordance with the preferred embodiments with the latch in its retracted position;

FIG. 8 is the back view of the housing of FIGS. 6 and 7 showing the slide button and the protruding members of the battery latch in accordance with the preferred embodiments;

FIG. 9 is a perspective view showing how a battery pack is pivoted into place using the battery latch of the preferred embodiments;

FIG. 10 is a cross-sectional view of the end stop 620 and side rails 630 and 640 of FIGS. 6-8 in accordance with the preferred embodiments;

FIG. 11 is an end view of the battery pack of FIG. 9 showing one end that includes recesses 1100 for receiving the protruding members of the battery latch;

FIG. 12 is a side view of the battery pack of FIG. 11 taken along the line 12-12;

FIG. 13 is an end view of the battery pack of FIG. 11 showing the opposite end of the battery pack that includes retaining tabs that help to hole the battery pack in place by placing the retaining tabs within corresponding battery pack retainer recesses in the housing;

FIG. 14 is a side view of the battery pack of FIG. 13 taken along the line 14-14; and

FIG. 15 is a flow diagram of a method for using the battery latch of the preferred embodiments.

### BEST MODE FOR CARRYING OUT THE INVENTION

The present invention provides a battery latch that is very low profile, and that does not require a separate steel spring. The battery latch allows a battery pack to be latched to a housing of a portable electronic device using one hand by pushing the battery pack in place. To remove the battery pack, a user slides a slide button to disengage the battery latch from the battery pack, and removes the battery pack from the housing. The removal operation thus generally requires the use of two hands. The battery latch of the preferred embodiments is easily assembled into a housing without using any tools. The result is a battery latch that is inexpensive and that is easily assembled without using a separate spring, yet positively retains the battery pack.

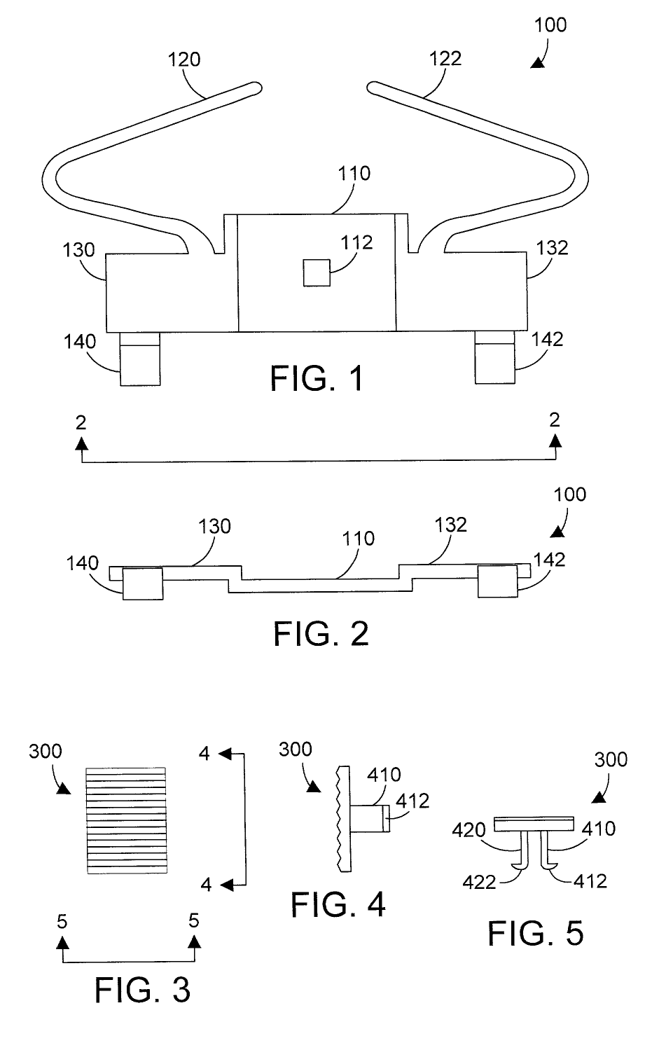

Referring now to FIG. 1, a battery latch 100 is made of a semi-rigid resilient material such as polycarbonate, nylon, polyvinylchloride, metal, or other suitable material. Battery latch 100 includes a central portion 110 that has an opening 112. On both sides of central portion 110 are side portions 130 and 132. Central portion 110 and side portions 130 and 132 collective make up a “body portion” of the battery latch 100. Extending from side portion 130 is an integral spring member 120. Likewise, extending from side portion 132 is integral spring member 122. Also extending from side portion 130 opposite the integral spring member 110 is a protruding member 140. Similarly, extending from side portion 132 opposite the integral spring member 122 is a protruding member 142.

An end view of the battery latch 100 of FIG. 1 taken along line 2-2 is shown in FIG. 2. The protruding members 140 and 142 are shown extending from their respective side portions 130 and 132. Note that protruding members 140 and 142 preferably have a beveled surface, as shown in FIG. 1. Note, however, that the specific shape of the protruding members 140 and 142 is not critical, so long as a battery pack that is pressed against the protruding members 140 and 142 will succeed in overcoming the bias of the integral spring members 120 and 122 so the battery pack can be latched into place.

FIGS. 3-5 show one specific implementation of a slide button in accordance with the preferred embodiments. Slide button 300 includes a top surface that preferably includes ridges, as shown in FIGS. 3 and 4. The ridges provide a surface that can be easily pressed and moved by the tip of a person's finger. Slide button 300 includes leg portions 410 and 420 with corresponding engaging portions 412 and 422. The legs of slide button 300 are preferably dimensioned smaller that the size of opening 112 in the battery latch 100. To install the battery latch 100 into a housing, the battery latch is placed in the housing, which has an elongated recess that lines up with the opening 112 in the battery latch 100, and the legs 410 and 420 of slide button 300 are placed through the slot in the housing into opening 112 until the engaging portions 412 and 422 snap into place within opening 112, which retains both the slide button 300 and the battery latch 100 on opposite sides of the housing. This configuration allows the battery latch to be assembled within a housing without using tools by simply snapping the slide button 300 through the housing into the battery latch 100.

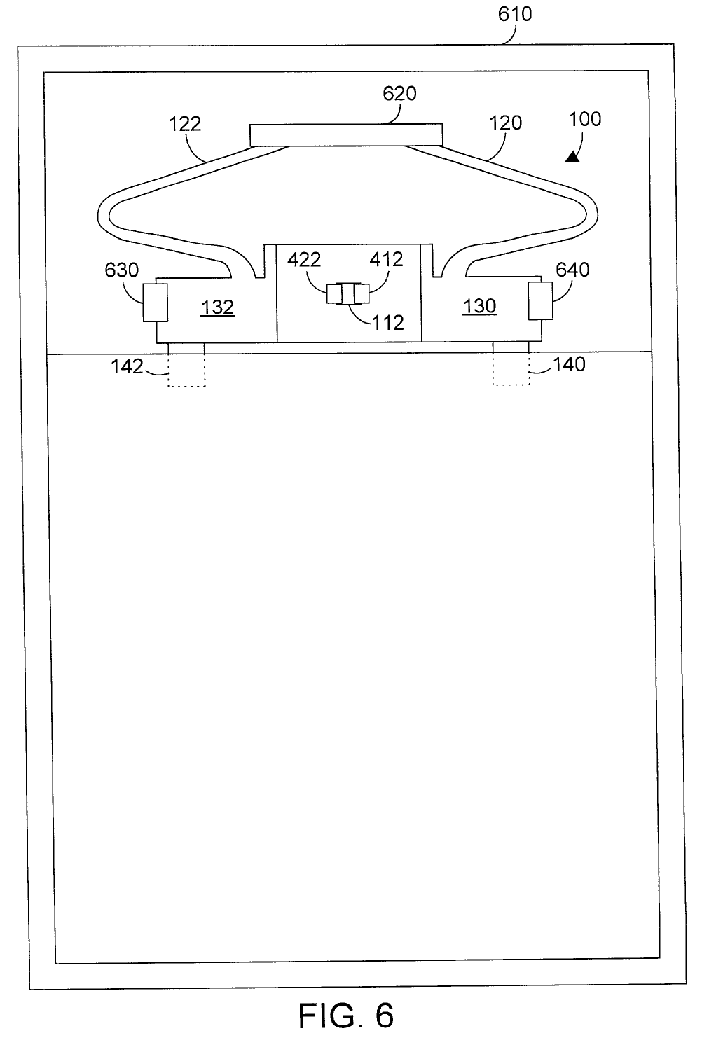

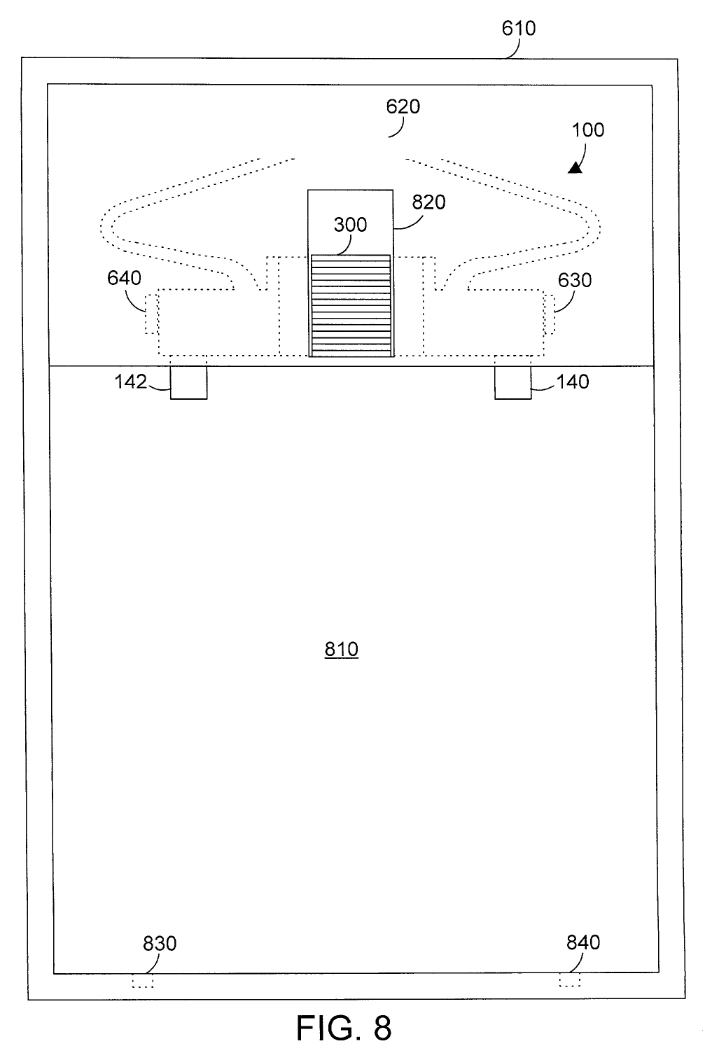

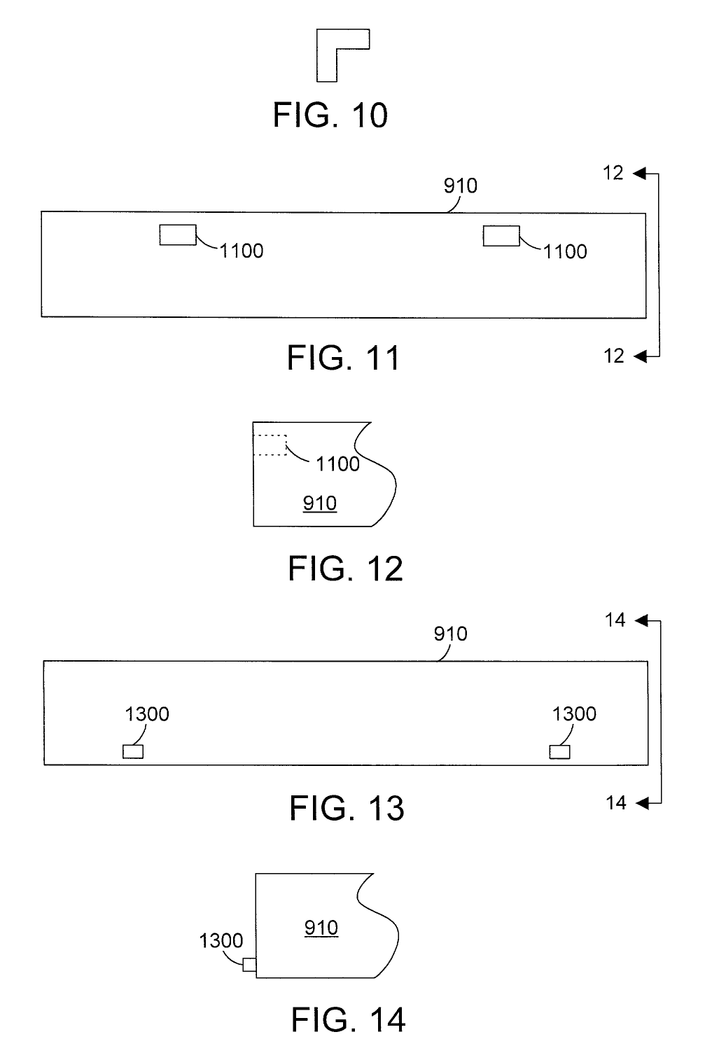

Referring now to FIG. 6, a battery latch 100 is shown assembled within a housing 610. Housing 610 represents any suitable housing for an electronic device. In the preferred embodiments, housing 610 is for a portable electronic device, but the present invention expressly extends to any housing for any device or product that needs to receive a battery pack. Housing 610 can be made of any suitable material now known or developed in the future, including die-cast metal (such as magnesium) and molded plastic. Housing 610 includes an end stop 620 and side rails 630 and 640. The end stop 620 and side rails 630, 640 each have an L-shaped cross-section, as shown in FIG. 10, and are preferably molded into housing 610 during the manufacturing of housing 610. The L-shaped cross-section of side rails 630 and 640 captivate the edges of respective side portions 132 and 130 in a manner that allows latch body 100 to slide up and down with respect to the slide rails 630 and 640 shown in FIG. 6. End stop 620 also has an L-shaped cross-section, which allows the tips of integral spring members 120 and 122 to be placed under the upper lip of end stop 620, thereby holding the tips of integral spring members 120 and 122 in place. In the preferred embodiments, there are no screws or other mechanisms within housing 610 that hold the battery latch 100 in place. The battery latch, once slid underneath rails 630 and 640 and once the tips of spring members 120 and 122 are place under the top lip of the end stop 620, is held in place by the slide button. In FIG. 6, the only portion of the slide button 300 that is visible are the retaining portions 412 and 422 that are extending through opening 112 of battery latch 100. Note that the integral spring members 120 and 122 and the side portions 130 and 132 are on opposite sides than shown in FIG. 1 because the battery latch 100 in FIG. 6 is upside-down compared to the battery latch of FIG. 1. Note that protruding portions 140 and 142 are shown in phantom to indicate that they extend into a battery compartment that is on the opposite side of the housing 610 shown in FIG. 6. With the protruding portions 140 and 142 extending into a battery compartment (as shown in FIGS. 6 and 8), the battery latch is said to be in an extended position.

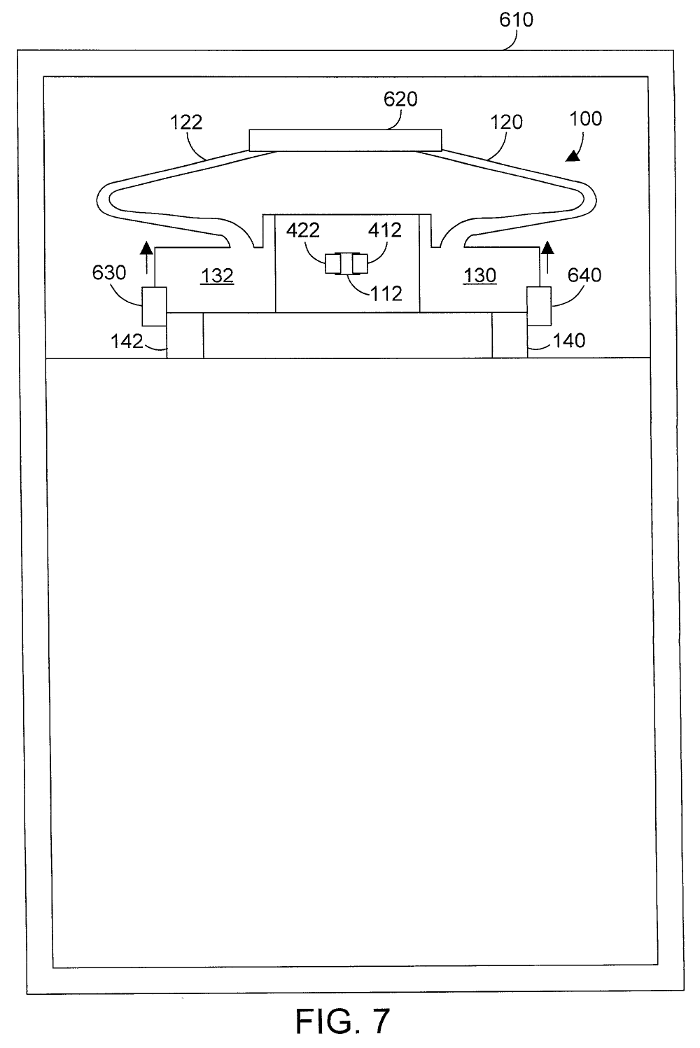

The sliding operation of the battery latch 100 is illustrated in FIG. 7. Note that spring members 120 and 122 have been compressed together compared to FIG. 6, which allows the side portions 130 and 132 to slide under the rails 640 and 630, respectively. This sliding motion retracts the protruding members 140 and 142 from the battery compartment. Note that the battery latch 100 can be in the retracted position shown in FIG. 7 in at least two different ways. For example, the battery latch can be in a retracted position by pushing a battery pack into the battery compartment of the housing, and just before the battery latch snaps into place (with the protruding members extending into corresponding recesses in the battery pack), the protruding members will be in a retracted position as shown in FIG. 7. Another way for the battery latch 100 to be in a retracted position, such as that of FIG. 7, is for a user to slide the slide button 300 (shown in FIG. 8), which overcomes the spring bias of the integral spring members 120 and 122 and slides the battery latch 100 into the retracted position. Sliding the slide switch 300 to move the battery latch 100 to its retracted position is especially useful in removing a battery pack from a battery compartment of the housing 610.

Referring now to FIG. 8, the opposite side of the housing 610 of FIGS. 6 and 7 is shown, which includes a battery compartment 810. Note that the battery latch 100, end stop 620, and side rails 630 and 640 are shown in FIG. 8 in phantom to indicate that they are on the opposite side of the housing 610. The top face of slide button 300 is visible, and is situated within an elongated recessed slot 820 in housing 610. Protruding members 140 and 142 extend within the battery compartment 810, and preferably have a beveled or curved surface exposed so that when a battery pack is pushed into the battery compartment 810, the force of the battery against the protruding members 140 and 142 causes the battery latch 100 to slide to its retracted position (see FIG. 7), allowing the battery pack to be pushed into place until the protruding members 140 and 142 extend into recesses within the battery pack that are designed to hold the battery pack securely in place by the protruding members 140 and 142. One suitable configuration for recesses 1100 in a battery pack 910 are shown in FIGS. 11 and 12.

Note that housing 610 of FIG. 8 includes recesses 830 and 840 that are designed to receive extending portions of the battery pack to hold the battery pack in place on the end of housing 610 that includes recesses 830 and 840. One suitable configuration for extending portions of a battery pack is shown in FIGS. 13 and 14, with the extending portions 1300 that extend from the battery pack 910 being designed to be received within the recesses 830 and 840 of FIG. 8.

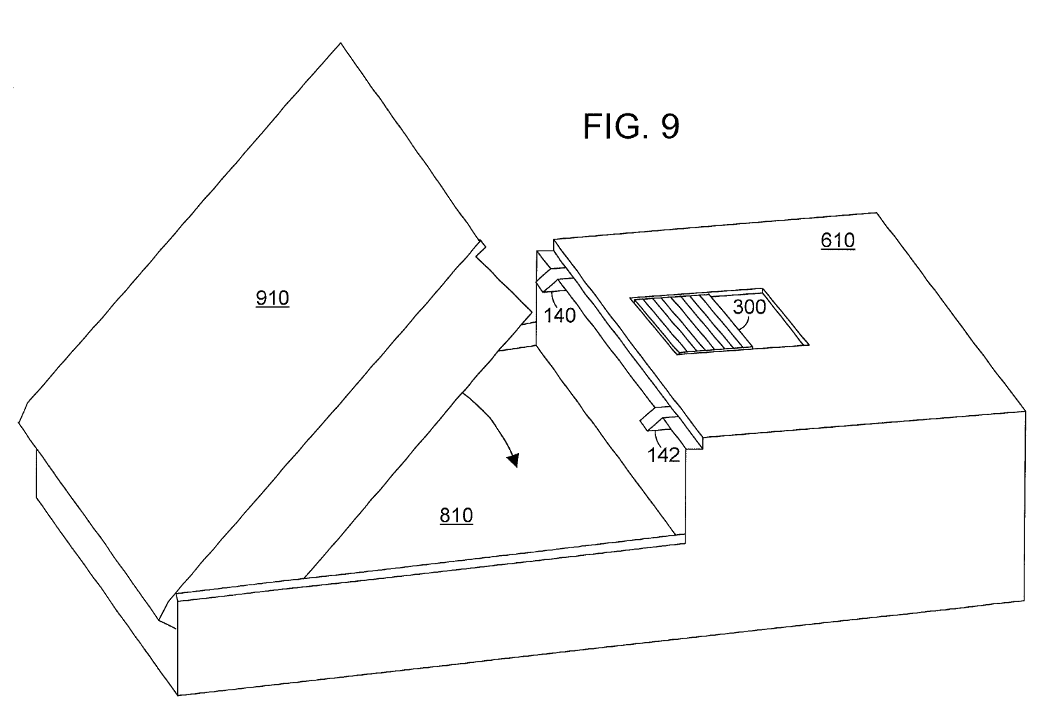

FIG. 9 represents a perspective view of housing 610 of FIGS. 6-8 when a battery pack 910 is being installed. We assume that battery pack 910 has extending portions that are placed within the corresponding recesses 830 and 840 shown in FIG. 8. Battery pack 910 is then pivoted into place within the housing, as shown by the arrow in FIG. 9. As the battery pack pivots, it will contact the protruding members 140 and 142 of the battery latch 100. Because the face of the protruding portions are appropriately shaped (such as the bevel shown in FIG. 9), as battery pack 910 is pivoted and pressed into the battery compartment 810 of housing 610, the battery pack 910 contacts the protruding members 140 and 142, and pushes the protruding members 140 and 142 clear from the battery compartment 810. This allows the battery pack 910 to be fully seated within the battery compartment 810. Once the battery pack 910 is fully seated within battery compartment 810, recesses (e.g., 1100 of FIGS. 11 and 12) in the battery pack 910 line up with protruding members 140 and 142. Due to the spring bias force provided by integral spring members 120 and 122, when the recesses in the battery pack line up with the protruding members 140 and 142, the battery latch slides back to its extended position (as shown in FIGS. 6 and 8), typically with a “click” sound. The protruding members 140 and 142 thus retain the battery pack 910 within the battery compartment 810 until a user desires to remove the battery pack. Note that installation of the battery pack 910 into the housing 610 that includes the battery latch of the preferred embodiments can be performed with one hand by simply placing the pivoting end of the battery pack 910 in place, and pivoting the opposite end of the battery pack past the protruding members into its fully seated position.

Removal of the battery pack 910 from housing 610 can be easily performed using the slide button 300. When a user desires to remove the battery pack, the slide button 360 is moved so the battery latch 100 is in its retracted position. In the specific example of FIG. 9, this means the slide button 300 is moved to the right, causing the protruding members 140 and 142 to retract. This frees the battery pack 910 from the protruding members 140 and 142, thus allowing the battery pack 910 to be removed from the battery compartment 810. While a skilled person might accomplish this operation with one hand, the normal mode of removing a battery pack would have a user slide the slide button 300 with one hand, while removing the battery pack 910 from the battery compartment 810 using the other hand.

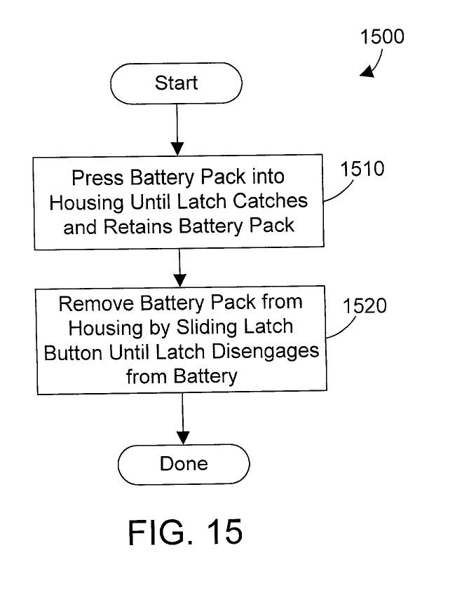

A method 1500 for using the latch disclosed in FIGS. 1 and 2 when assembled into a housing is shown in FIG. 15. A battery pack may be placed within the housing by pressing the battery pack into the battery compartment of the housing until the latch snaps into the recesses in the battery pack, thereby retaining the battery pack (step 1510). Once the battery pack is in the battery compartment of the housing and is being retained by the battery latch, the battery pack may be removed by sliding the slide button until the battery latch disengages from the battery (step 1530) (i.e., until the battery latch is in its retracted position), at which time the battery pack may be removed from the housing.

The battery latch, slide button, and housing disclosed herein provide a very simple yet effective way to retain a battery in a portable electronic device. The battery latch includes integral spring members that make a separate steel spring unnecessary. The battery latch is retained within the housing by passing the slide button through a slot in the housing and into the battery latch until the slide button snaps into the battery latch. The battery latch is very low-profile, allowing its use in very tight housings. In addition, the battery latch allows a user to install a battery pack into a housing using one hand and to easily remove the battery pack from the housing using two hands.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention. For example, while a single battery latch is shown herein, it will be obvious to use multiple battery latches to retain a battery pack. In addition, while the battery latch is shown in the figures herein as part of the housing and separate from the battery pack, it is equally within the scope of the preferred embodiments to place the battery latch in a battery pack, with corresponding recesses in the housing. These and other modifications are within the scope of the preferred embodiments.

We claim:

1. A battery latch comprising:
a body portion;
at least one resilient spring member integral to and extending from the body portion;
at least one protruding member integral to and extending from the body portion, the at least one resilient spring member biasing the at least one protruding member to an extended position.

2. The battery latch of claim 1 wherein the at least one protruding member extends at least partially into a battery compartment of a housing when the battery latch is installed in the housing when the at least one protruding member is in the extended position.

3. The battery latch of claim 1 wherein the at least one protruding member extends at least partially into at least on recess in a battery compartment of a housing when the battery latch is installed in a battery pack when the at least one protruding member is in the extended position and when the battery pack is installed in the battery compartment of the housing.

4. The battery latch of claim 1 further comprising a slide button removably coupled to the body portion that allows the body portion to slide against a biasing force of the at least one resilient spring member.

5. The battery latch of claim 1 wherein the slide button comprises at least one retaining portion that may be coupled to the battery latch by sliding the at least one retaining portion into an opening in the battery latch until the at least one retaining portion clicks to coupled the slide button to the body portion.

6. A housing for a portable electronic device comprising:
first and second rails in the interior of the housing;
an end stop in the interior of the housing;
a battery compartment defined by a recess in the housing;
a battery latch dimensioned to slide between the first and second rails, the battery latch including at least one resilient spring member integral to the battery latch, the at least one resilient spring member being placed against the end stop to provide a spring bias that causes the battery latch to slide to an extended position, the battery latch including at least one protruding member that extends at least partially into the battery compartment when the battery latch is in the extended position; and
a slide button coupled to the battery latch and accessible on the outside of the housing, the slide button allowing a user to slide the slide button and thereby move the battery latch to a retracted position that removes the at least one protruding member from the battery compartment.

7. The housing of claim 6 wherein the at least one protruding member includes a geometric surface that allows a battery pack to be installed into the battery compartment by pressing the battery pack into the battery compartment, the force of pressing the battery pack overcoming the biasing force of the at least one resilient spring member to move the at least one protruding member to the retracted position.

8. The housing of claim 7 wherein the geometric surface comprises a beveled surface.

9. The housing of claim 7 wherein the geometric surface comprises a curved surface.

10. The housing of claim 6 wherein the battery latch returns to the extended position with the at least one protruding members in at least one corresponding recess in the battery pack when the battery pack is fully seated in the battery compartment.

11. A battery pack comprising:
first and second rails in the interior of the battery pack;
an end stop in the interior of the battery pack;
a battery latch dimensioned to slide between the first and second rails, the battery latch including at least one resilient spring member integral to the battery latch, the at least one resilient spring member being placed against the end stop to provide a spring bias that causes the battery latch to slide to an extended position, the battery latch including at least one protruding member that extends at least partially out of the battery pack when the battery latch is in the extended position; and
a slide button coupled to the battery latch and accessible on the outside of the battery pack, the slide button allowing a user to slide the slide button and thereby move the battery latch to a retracted position that retracts the at least one protruding member into the battery pack.

12. The battery pack of claim 11 wherein the at least one protruding member includes a geometric surface that allows the battery pack to be installed into a battery compartment of a housing by pressing the battery pack into the battery compartment, the force of pressing the battery pack overcoming the biasing force of the at least one resilient spring member to move the at least one protruding member to the retracted position.

13. The battery pack of claim 12 wherein the geometric surface comprises a beveled surface.

14. The battery pack of claim 12 wherein the geometric surface comprises a curved surface.

15. The battery pack of claim 11 wherein the battery latch returns to the extended position with the at least one protruding members in at least one corresponding recess in a housing when the battery pack is fully seated in a battery compartment within the housing.

16. A combination of a housing and a battery pack,
(A) the housing comprising:
(A1) first and second rails in the interior of the housing;
(A2) an end stop in the interior of the housing;
(A3) a battery compartment defined by a recess in the housing;
(A4) a battery latch dimensioned to slide between the first and second rails, the battery latch including at least one resilient spring member integral to the battery latch, the at least one resilient spring member being placed against the end stop to provide a spring bias that causes the battery latch to slide to an extended position, the battery latch including at least one protruding member that extends at least partially into the battery compartment when the battery latch is in the extended position;
(A5) a slide button coupled to the battery latch and accessible on the outside of the housing, the slide button allowing a user to slide the slide button and thereby move the battery latch to a retracted position that removes the at least one protruding member from the battery compartment;
(A6) at least one battery pack retainer recess;
(B) the battery pack comprising:
(B1) an enclosure having at least a portion dimensioned to fit within the battery compartment;
(B2) the portion of the enclosure including at least one extending portion that is configured to go in the at least one battery pack retainer recess of the housing when the battery pack is installed in the housing; and
(B3) the portion of the enclosure including at least one recess that aligns with and receives the at least one protruding member when the battery pack is installed in the housing.

17. A method for removably coupling a battery pack to a housing of a portable electronic device, the method comprising the steps of:
(A) providing a battery latch within the housing, the battery latch comprising:
(A1) a body portion;
(A2) at least one resilient spring member integral to and extending from the body portion;
(A3) at least one protruding member that extends at least partially into a battery compartment defined in the housing, the at least one resilient spring member biasing the at least one protruding member into the battery compartment;
(B) installing a battery pack into the battery compartment, the battery pack comprising at least one recess that receives the at least one protruding member when the battery pack is installed in the battery compartment of the housing, the battery pack being installed by pressing the battery pack against the at least one protruding member, thereby forcing the at least one protruding member against the bias of the at least one resilient spring member until the battery latch slides to a retracted position, allowing the battery pack to move past the at least one protruding members until the at least one protruding member is biased into the at least one recess of the battery pack when the battery pack is fully seated in the battery compartment of the housing.

18. The method of claim 17 further comprising the step of:
(C) removing the battery pack from the battery compartment by sliding a slide button coupled to the battery latch until the at least one protruding member is in the retracted position and removing the battery pack from the battery compartment while holding the slide button in a position so that the battery latch is in the retracted position.

19. A method for assembling a battery latch and a slide button into a housing,
(A) the battery latch comprising:
(A1) a body portion;
(A2) at least one resilient spring member integral to and extending from the body portion; and
(A3) at least one protruding member integral to and extending from the body portion that extends at least partially into a battery compartment of a housing when the battery latch is installed in the housing, the at least one resilient spring member biasing the at least one protruding member into the battery compartment;
(B) the slide button comprising:
(B1) at least one retaining portion that is configured to be inserted into an opening in the battery latch;
(C) the housing comprising:
(C1) first and second rails in the interior of the housing;
(C2) an end stop in the interior of the housing;
(C3) a battery compartment defined by a recess in the housing;
(C4) the battery latch being dimensioned to slide between the first and second rails, the battery latch including at least one resilient spring member integral to the battery latch, the at least one resilient spring member being placed against the end stop to provide a spring bias that causes the battery latch to slide to an extended position, the battery latch including at least one protruding member that extends at least partially into the battery compartment when the battery latch is in the extended position, the battery latch further including at least one opening; and
(C5) an elongated slot, a portion of the elongated slot overlying the at least one opening of the battery latch;
(D) wherein the method comprises the steps of:
(D1) sliding the body portion under the first and second rails;
(D2) placing end portions of the resilient spring members against the end stop;
(D3) placing the retaining portions of the slide button through the elongated slot in the housing and into the opening in the battery latch until the at least one retaining portion clicks to coupled the slide button to the body portion through the elongated slot in the housing.
